(19) United States
(12) Patent Application Publication
(10) Pub. No.: US 2005/0262147 A1
(43) Pub. Date: Nov. 24, 2005

(54) Insurance program for portable media players

(76) Inventor: Peter S. Lee, Calabasas Park, CA (US)

Correspondence Address: THE WALT DISNEY COMPANY;C/O GREENBERG TRAURIG LLP, 2450 COLORADO AVENUE SUITE 400E, SANTA MONICA, CA, 90404, US

(21) Appl. No.: 11/100,698

(22) Filed: Apr. 6, 2005

Related U.S. Application Data
(60) Provisional application No. 60/570,023, filed on May 10, 2004.

(51) Int. Cl. G06F 7/00

(52) U.S. Cl. 707/104.1

(57) ABSTRACT

An insurance program is provided for a portable media player wherein such player has media content or data downloaded thereon. The program provides for the replacement of such stored media or data due to loss of data, corrupted or missing files, etc. Such program is specific to the player and may also be programmed to upgrade such media or compensate the owner for the loss of such media.

### RELATIONSHIP TO PRIOR APPLICATIONS

This application is a non-provisional application based on Provisional Application Ser. No. 60/570,023, filed May 10, 2004.

### BACKGROUND OF THE DISCLOSURE

1. Field of the Disclosure

The disclosure relates to portable media players; and, particularly, to an insurance program built into the player to compensate the user for data loss and corrupted programs or the like or replace the same.

2. Related Art

Portable media players (PMP) are well known in the art. These players are usually pocket size devices that can store hundreds of movies, games or other media on a built-in hard drive or other storage means and play the same back when desired. The media, games, photos or the like are thus stored on local storage, such as a built in hard drive, memory card, or other removable storage.

If a PMP file is lost because of a computer crash or some other reason, generally the user has no option but to purchase another program for downloading.

There is a need for a program built in to a PMP for replacing lost or damaged media or otherwise compensating the owner for the lost or damaged files.

### SUMMARY

It is an object of this disclosure to provide a built-in insurance program for portable media players which, if a media file is lost or damaged because of a computer crash or some other reason, the insurance program may be activated to replace the lost or damaged file or otherwise compensate the owner for such lost or damaged files.

It is a further object of this disclosure to link specific files with the unique portable media player to which the files have been downloaded so that the downloaded media file cannot be redistributed to another PMP and the insurance program covers replacement of, or compensation for, only the damaged or lost files in that specific PMP.

It is a further object of the disclosure to provide such an insurance program for a specific portable media player where upgrades of downloaded software purchased on line from a designated website are covered by the program if the original software is lost or damaged.

It is further object of this disclosure to provide such an insurance program wherein a particular media or data program is downloaded by a user to a specific computer, then copied, with authorization, to a specific PMP.

It is still another object of this disclosure to provide an insurance program which can only be utilized to cover media files or data on a specific PMP.

It is another object of this disclosure to provide such an insurance program which covers those media files or data files associated with a specific user's domain, the files being the downloaded to one or more devices, such as a PMP, associated with that particular.

### DESCRIPTION OF THE PREFERRED EMBODIMENT

A portable media player is provided which is adapted to store and playback various media, that may be downloaded after purchase, or purchased by subscription or the like, such as:
1. Personal video content;
2. Media company content, including, but not limited to movies, broadcast content, trailers, etc.;
3. Music;
4. Voice recordings;
5. Photos and other images;
6. Data in general.

The present disclosure contemplates a replacement insurance program for the foregoing media purchased for use on a PMP. The insurance program provides for either replacement of lost or damaged media, a monetary payment, or both. Thus, if for any reason, such as a computer or system crash, drive crash, lost or stolen PMP, etc., or otherwise damaged or corrupted files, insurance, previously paid for by the user, would replace or otherwise compensate for the previously downloaded file. The previously downloaded file is locked to a specific PMP so fraud is prevented and it cannot be redistributed. If the original software is lost, or has been upgraded, the insurance provides an upgrade by either installing a new program, build on the original program, reinstallation of the original program, if corrupted or otherwise lost, etc.

Preferably, the user's purchase of the software program to be downloaded to the user's PMP is logged into a database provided by the originator of the program. This may be carried out in a number of ways, including, but not limited to, the login identification of the user, the serial number or other information relating to the specific PMP, the insurance policy purchased by the user, etc. That is, the disclosure herein provides for a system that tracks the consumer's purchase (e.g., user ID, PMP serial number, purchase date, content title, price, where the data or media was purchased, file type, format/resolutions, etc.) and, in case of lost or damaged media, either automatically or manually sends a replacement file (electronically or physically) to the consumer or otherwise compensates the consumer. This file can be loaded automatically or manually onto the PMP device (i.e., on to the same PMP device, or, in case of theft, on to a new PMP device). If the latter is the case, and the PMP device is a replacement, a record is kept identifying the serial number of the lost or stolen device.

If the user's program crashes, the insurance policy may be activated automatically when the player is connected up to a computer with an open internet connection, or by telephone, etc. The home server or program originator may detect the loss of content or program corruption automatically and provide a replacement program. The detection would include determining the coverage of the insurance policy, whether full coverage of any downloaded program, or specific to a single program, or a combination of programs. The specific software program that was lost or damaged is thus replaced with a new program along with a new license or insurance program. Such new license or insurance program would render the original program obsolete so that, if the original program was somehow recovered, it will not play. The insurance program may have some flexibility in the number of times a claim may be made under the program, such by user or the people in the user's household, the specific player, the particular content, etc. and how the program is replaced (e.g., by sending a new file, the original file, a key to unlock a file at some remote location, etc.). Alternatively, the owner may be compensated for such loss.

In summary, a portable media player having built-in or removable medial software storage means for storing media software on the player is provided having an insurance program associated therewith for insuring the owner of the player from various calamities. The media software storage means links any media software to the specific player so that it can be identified to that particular player and user. The content can be downloaded from the web or loaded from physical media such as DVD, CD, or other like memory storage means. Such storage means may be built-in or removable from the player and the insurance program may be initiated by the owner of the player if the player is lost or stolen.

It is contemplated that the PMP should connect to a PC. The PC should be able to manage the files on the PMP using a tool similar to Windows File Manager, a proprietary file managing system owned by Microsoft, Inc. Files can be copied from the PMP to the PC and vice versa, as long as all content protection remains with the files. The user should have an easy mechanism to transfer content from a PC to the PMP. The PMP should enable the user to view, manage, and manipulate the files on the PMP using tools like Windows File Manager (i.e., drag & drop files, create and manage folders, rename files, etc) or any other file management or control manager system, such as iTunes, a proprietary service of Apple Computer Inc. of Cupertino, Calif.

The PMP should also interface with software that may reside on the PC. The PMP should be able to connect to the PC via a cradle. The PMP can then be inserted into the PC cradle where it automatically syncs with the PC to transfer any new movies, music, or images from the PC based on user selected profiles (e.g., select all new files, select only new files on a specific date or genre, parents or children' profile, etc). The PMP should also enable the content to be synchronized with the PC based on consumer profiles (i.e. kids, parents, or a specific person). The profile would specify what types of content to copy down to the PMP. For example, Dad may want sports, R rated movies, easy listening songs, and images of the kids when he travels. Such downloaded media may have the insurance program contemplated herein provided along with the specific media so that it pertains only to that media.

The disclosure herein contemplates that the PMP user registers its device with the provider.

The purpose of registration would be to require the customer to accept the usage rules for content for PMP devices, mechanism to unlock files for PMP use, gather account information (name, address) for 1-click purchases, as well as insurance programs for replacement or compensation of corrupted or lost files, etc, and for forensic tracking of content files.

The user must register to use or purchase PMP files. Once the purchase is complete, the file will be bound to the primary personal computer (PC) of the user. Based on the license restrictions set by the media company for each title, the user may be able to:
Transfer the PMP file to another PC
Transfer the PMP file to an approved PMP
Transfer the PMP file to other users
Create a backup PMP file on CD

Once the file is bound to the user PC, it is the user's responsibility to maintain the content. Purchased PMP files will not be replaced if lost, stolen, or otherwise damaged unless insurance is provided, as discussed herein.

Thus, the disclosure herein contemplates an insurance program built in to a portable media player having media content associated therewith, for replacing or otherwise compensating the owner of the PMP for corrupted or damaged files, missing files, loss of data, etc. The program is tied to the particular PMP and may also cover upgraded or improved programs. Such a program protects the owner of the PMP from computer crashes, etc. The media stored or downloaded to the PMP built-in hard drive, or removable storage means, may originate from an external source, such as a DVD, CD, memory storage card, etc.

The database on the PMP may be programmed to detect a change in a program on the PMP and trigger the insurance program. When the changed program is replaced or the user is otherwise compensated for the lost, damaged or corrupted program or the like, a new replacement insurance program may be sent to the PMP rendering the original insurance program obsolete. The insurance program contemplated herein may be keyed to a single program stored on the PMP to the exclusion of others. The database may be resident on the PMP or on the user's computer.

Although the insurance program contemplated herein may be triggered by a damaged, lost or corrupted program, the program may be preset for activation from a remote database, e.g., the users computer, or website, when the PMP is coupled to the same as through a personal computer, to automatically replace or upgrade media stored on the PMP. Such may be preset for a pre-determined number of times that is recorded on the remote database. Such a preset insurance program may also be dependent on certain predetermined parameters stored in the remote database.

The media stored on the PMP may be provided in a built-in hard drive, removable media, such as a flash card, memory stick, etc. Such media may be locked to the particular PMP so that the insurance program contemplated herein is only effective with that particular PMP.

Although the insurance program contemplated herein may be automatically activated, as heretofore discussed, it may be activated by the owner of the PMP if the owner detects a lost or damaged or corrupted file or the like. Such an insurance program may compensate the owner of the PMP for the loss of the program rather than replacing the same.

Although the disclosure disclosed herein has been discussed with respect to a portable media player that receives data from a host computer, the insurance program may be resident on either the player or at the host computer. Further, although specific types of physical media are disclosed, obviously such types of technology is growing rapidly and the disclosure herein is considered as applicable to all presently known storage means and methodology for storing the same, such as SmartMediaMMC/SD, CompactFlash, Memory Stick, UMD, BluRay, Bluetooth, HD DVD, CD, etc., and other such means and methodology that will come along in the future.

Thus, there is disclosed a portable media player having built-in medial software storage means for storing media software and other data programs downloaded from a remote location to the player. The player includes an insurance program associated with media storage means for covering corruption or loss of software or data in the original media software or data on the player.

Such media software and other data is downloaded to the portable media player from the user's computer and the coverage provides for replacement of such software or data corrupted or lost due to a crash on either the computer or the portable media player. The coverage may provide for replacement of a corrupt program on the player or upgrading of the original media software or data stored on the player. The coverage may provide for replacing a missing file from the media software or data file on said player.

The coverage may compensate the owner of the player for any lost, corrupted or missing media software or data on the player. The media software storage means may include linking means for linking any media software or data to a specific player so that it can be identified to a particular player and user. The insurance program may be coupled to the linking means so that the insurance program can only be activated on the specific player to which the media software or data has been downloaded.

The media software or data may be downloadable from a website, the website having a database related to both the user of the player and the player itself whereby the insurance program may be activated if a downloaded program on the player crashes or is otherwise corrupted. The media software or data is downloadable from physical media containing the software. Such physical media may be a DVD, a compact disk, or a memory storage device.

The database may be programmed to notify the user of the player automatically if a change in a downloaded program on the player is detected. The database may be programmed to send a new insurance program along with the replacement downloaded program and may be programmed to render the original insurance program obsolete when a new insurance program is sent. The insurance program may specifically related to a single media software or unit of data downloaded to the player out of other software or data downloaded to the player.

The insurance program may be preset for activation by a remote database to replace or upgrade media stored on the player a predetermined number of times recorded on the database. The insurance program may be preset for activation by a remote database to replace or upgrade media or data stored on the player dependent on certain predetermined parameters stored in the database.

Although a particular embodiment of the disclosure is disclosed, variations thereof may occur to an artisan and the scope of the disclosure is only to be limited by the scope of the appended claims.

1. In a portable media player having built-in medial software storage means for storing media software and other data programs downloaded from a remote location to said player, the improvement which comprises:
an insurance program associated with said media storage means for covering corruption or loss of software or data in the original media software or data on said player.

2. The player of claim 1 wherein said media software and other data is downloaded to the portable media player from the users computer and said coverage provides for replacement of such software or data corrupted or lost due to a crash on either said computer or said portable media player.

3. The player of claim 1 wherein said coverage provides for replacement of a corrupt program on said player.

4. The player of claim 1 wherein said coverage provides for upgrading of the original media software or data stored on said player.

5. The player of claim 1 wherein said coverage provides for replacing a missing file from said media software or data program on said player.

6. The player of claim 1 wherein said coverage compensates the owner of said player for any lost, corrupted or missing media software or data on said player.

7. The player of claim 1 wherein said media software storage means includes linking means for linking any media software or data to a specific player so that it can be identified only to the owner of that specific player.

8. The player of claim 7 wherein said insurance program is coupled to said linking means so that said insurance program can only be activated on the specific player to which the said media software or data has been downloaded.

9. The player of claim 1 wherein said media software or data is downloadable from a website, said website having a database related to both the user of said player and said player itself whereby said insurance program may be activated if a downloaded program on said player crashes or is otherwise corrupted.

10. The player of claim 1 wherein said media software or data is downloadable from physical media containing said software.

11. The player of claim 10 wherein said physical media is a DVD.

12. The player of claim 10 wherein said physical media is a compact disk.

13. The player of claim 10 wherein said physical media is a memory storage device.

14. The player of claim 9 wherein said database is programmed to notify the user of said player automatically if a change in a downloaded program on said player is detected.

15. The player of claim 14 wherein said database is programmed to send a new insurance program along with the replacement downloaded program.

16. The player of claim 15 wherein said database is programmed to render the original insurance program obsolete when a new insurance program is sent.

17. The player of claim 1 wherein said insurance program is specifically related to a single media software or unit of data downloaded to said player out of other media software or data downloaded to said player.

18. The player of claim 1 wherein said insurance program is preset for activation by a remote database to replace or upgrade media stored on said player a predetermined number of times recorded on said database.

19. The player of claim 1 wherein said insurance program is preset for activation by a remote database to replace or upgrade media or data stored on said player dependent on certain predetermined parameters stored in said database.

20. A portable media player comprising:
(a) media software storage means for storing downloaded media software and data on said player; and
(b) an insurance program associated with said storage means for covering lost or corrupted files in the original media software and data stored on said player.

21. The player of claim 20 wherein said media software storage means is built-into said player.

22. The player of claim 20 wherein said media software storage means is on a removable device removably mounted in said player.

23. The player of claim 20 wherein said insurance program is adapted to alter said media by replacing the same due to corruption or loss of the original media or data.

24. The player of claim 20 wherein said coverage provides for compensation to the owner of said player for any lost, corrupted or missing media software or data on said player.

25. The player of claim 22 wherein said removable device is a flash card.

26. The player of claim 22 wherein said removable device is a memory stick.

27. The player of claim 22 wherein said removable device is a memory card.

28. The player of claim 20 wherein said insurance program is adapted to alter said media or data by upgrading the same due to changes in the original media software or data.

29. The player of claim 20 wherein said media software storage means includes locking means for locking any software downloaded to said storage means so that it cannot be distributed to a different player.

30. The player of claim 28 wherein said insurance program is coupled to said locking means so that said insurance program can only be activated on the specific player to which said media software or data has been downloaded.

31. The player of claim 20 wherein said media software is downloadable from a website, said website having a database related to the user of said player and said player whereby said insurance program may be activated if a downloaded program or media on said player crashes or is otherwise corrupted.

32. The player of claim 31 wherein said database is programmed to notify the user of said player automatically if a change in a downloaded program on said player is detected.

33. The player of claim 31 wherein said database is programmed to send a new insurance program along with the replacement downloaded program.

34. The player of claim 33 wherein said database is programmed to render the original insurance program obsolete when a new insurance program is sent.

35. The player of claim 20 wherein said insurance program is specifically related to a single media software or unit of data downloaded to said player out of other media software or data downloaded to said player.

36. The player of claim 20 wherein said insurance program is preset for activation by a remote database to replace or upgrade media stored on said player a predetermined number of times recorded on said database.

37. The player of claim 20 wherein said insurance program is preset for activation by a remote database to replace or upgrade media stored on said player dependent on certain predetermined parameters stored in said database.

38. The player of claim 20 wherein said media software is downloadable from a physical media containing the software.

39. A portable media player comprising:
(a) media software storage means for storing downloaded media software on said player; and
(b) an insurance program associated with said player insuring both said player from loss or theft thereof and said media software from loss or corruption thereof.
